(19) United States
(12) Patent Application Publication
(10) Pub. No.: US 2026/0283122 A1
(43) Pub. Date: Sep. 24, 2026

(54) INFORMATION PROCESSING APPARATUS

(71) Applicant: NEC Corporation, Tokyo (JP)

(72) Inventor: Shigenori INOUE, Tokyo (JP)

(73) Assignee: NEC Corporation, Tokyo (JP)

(21) Appl. No.: 19/434,144

(22) Filed: Dec. 29, 2025

(30) Foreign Application Priority Data
Jan. 30, 2025 (JP) 2025-013934

(51) Int. Cl. A01K 61/85; A01K 61/95; G06V 10/70; G06V 40/10

(52) U.S. Cl. CPC A01K 61/85; A01K 61/95; G06V 10/70; G06V 40/10

(57) ABSTRACT

An information processing apparatus according to the present disclosure includes an acquisition unit that acquires abdomen information indicating a state of an abdomen of an animal during feeding by a feeder, and a control unit that controls a feeding status by the feeder based on the abdomen information.

### INCORPORATION OF BASIC APPLICATION

The present invention claims the benefit of the priority of Japanese Patent Application No. 2025-013934 filed on Jan. 30, 2025 in Japan, the contents of which are incorporated herein by reference in its entirety.

### TECHNICAL FIELD

The present disclosure relates to an information processing apparatus.

### BACKGROUND ART

In fish farming, automatic feeding is performed using a feeder. For example, PTL 1 describes that stomach information indicating a size of a stomach of fish in a fish tank is acquired and a feeding start timing is controlled from the stomach information.

PTL 1: Japanese Unexamined Patent Application Publication No. 2024-100078

### SUMMARY

However, as described in PTL 1, even if the feeding start timing is controlled according to the size of the stomach of the fish, feeding may be excessive or insufficient. As a result, there arises a problem that it is difficult to perform appropriate feeding. The problem may occur in a case where any animal is raised not only in fish farming, but also in the livestock industry in which farm animals are raised.

Therefore, one of the objects of the present disclosure is to solve the above problem that it is difficult to appropriately feed an animal.

An information processing apparatus that is one aspect of the present disclosure has a configuration including
an acquisition unit that acquires abdomen information indicating a state of an abdomen of an animal during feeding by a feeder and
a control unit that controls a feeding status by the feeder, based on the abdomen information.

An information processing method that is one aspect of the present disclosure performed by an information processing apparatus, has a configuration including
acquiring abdomen information indicating a state of an abdomen of an animal during feeding by a feeder and
controlling a feeding status by the feeder, based on the abdomen information.

A program that is one aspect of the present disclosure has a configuration for causing an information processing apparatus to execute processing for
acquiring abdomen information indicating a state of an abdomen of an animal during feeding by a feeder and
controlling a feeding status by the feeder, based on the abdomen information.

An information processing system that is one aspect of the present disclosure has a configuration including
a feeder that performs feeding into a space where an animal is raised,
an imaging device that images the animal, and
an information processing apparatus that acquires a captured image by the imaging device and controls a feeding status by the feeder, in which
the information processing apparatus includes
an acquisition unit that acquires abdomen information indicating a state of an abdomen of the animal during feeding by the feeder, from the captured image by the imaging device, and
a control unit that controls a feeding status by the feeder, based on the abdomen information.

With the above configuration, the present disclosure can appropriately feed an animal.

### BRIEF DESCRIPTION OF THE DRAWINGS

FIG. 1 is a block diagram illustrating an example of a configuration of a feeding system according to the present disclosure;

FIG. 2 is a block diagram illustrating an example of the configuration of the feeding system according to the present disclosure;

FIG. 3 is a diagram illustrating an example of a state of processing by the feeding system according to the present disclosure;

FIG. 4 is a diagram illustrating an example of the state of the processing by the feeding system according to the present disclosure;

FIG. 5 is a diagram illustrating an example of the state of the processing by the feeding system according to the present disclosure;

FIG. 6 is a diagram illustrating an example of the state of the processing by the feeding system according to the present disclosure;

FIG. 7 is a flowchart illustrating an example of a processing operation by the feeding system according to the present disclosure;

FIG. 8 is a flowchart illustrating an example of the processing operation by the feeding system according to the present disclosure;

FIG. 9 is a flowchart illustrating an example of the processing operation by the feeding system according to the present disclosure;

FIG. 10 is a block diagram illustrating an example of a hardware configuration of an information processing apparatus according to the present disclosure;

FIG. 11 is a block diagram illustrating an example of a configuration of the information processing apparatus according to the present disclosure; and

FIG. 12 is a flowchart illustrating an example of a processing operation by the information processing apparatus according to the present disclosure.

### EXAMPLE EMBODIMENT

### First Example Embodiment

A first example embodiment of the present disclosure will be described with reference to the drawings. The drawings may relate to any example embodiment.

The present disclosure relates to a feeding system that feeds a raised animal. In the present example embodiment, a feeding system used in a scene where fish such as tuna, yellowtail, or salmon are farmed in a fish tank will be described as an example.

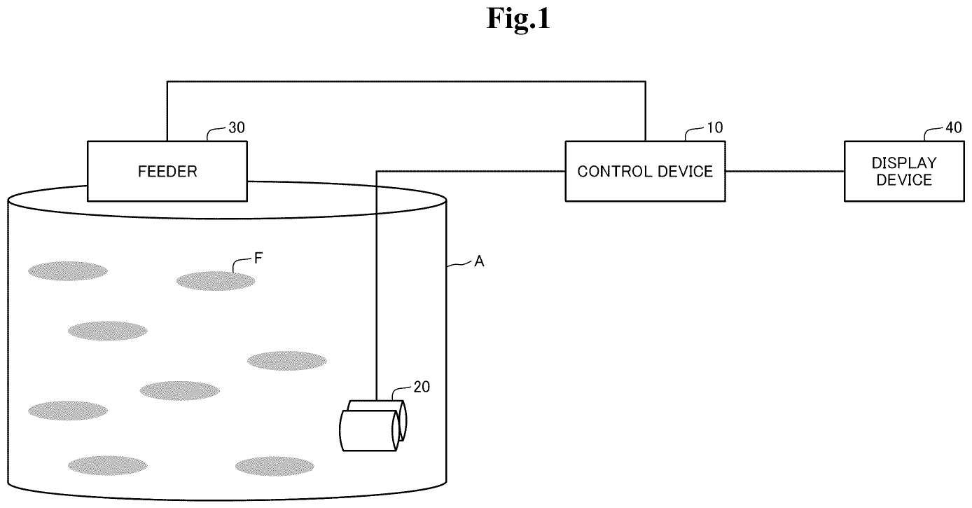

As illustrated in FIG. 1, the feeding system (information processing system) in the present example embodiment includes a camera 20 installed in a fish tank A, a feeder 30 that puts food into the fish tank A, a control device 10 that controls a feeding status of the feeder 30, and a display device 40 that displays information regarding the feeding. Hereinafter, a configuration and an operation of each configuration will be described.

The fish tank A forms a space where fish F is raised (farmed). For example, the fish tank A may be formed by a container, or may be formed by a region surrounded by a net or the like in the ocean. Then, in the present example embodiment, it is assumed that a plurality of fish F of the same type be raised in the fish tank A. A plurality of types of the fish F may be raised in the fish tank A.

The camera 20 is an imaging device that images the fish F in the fish tank A. The camera 20 includes, for example, a stereo camera and can image a stereoscopic image. Then, the camera 20 inputs a captured image to the control device 10. The camera 20 may be any imaging device such as a monocular camera.

The feeder 30 is a device that is installed in the fish tank A and feeds the fish F raised in the fish tank A. The feeder 30 is installed, for example, near a water surface of the fish tank A. Then, the feeder 30 supplies food into the fish tank A, in response to a command from the control device 10. The food supplied from the feeder 30 is fish meal, a pellet obtained by solidifying fish meal, raw fish, or the like.

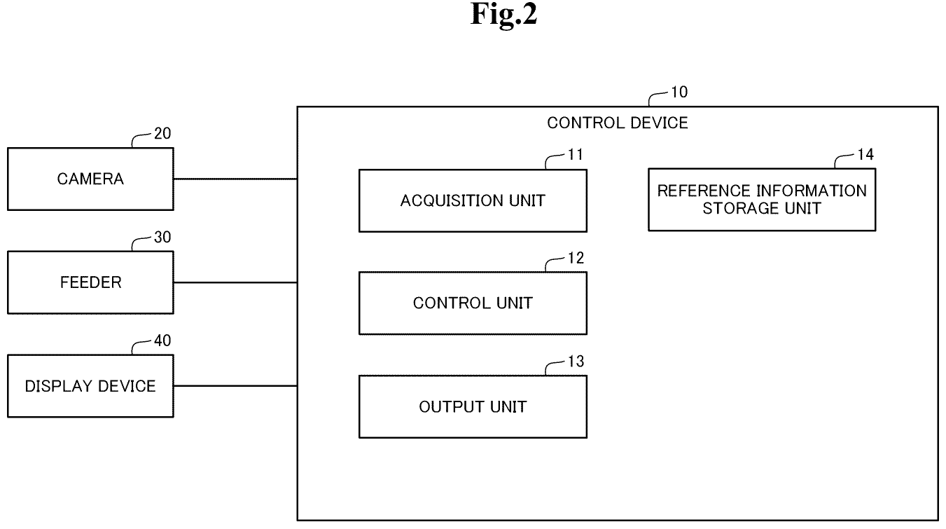

The control device 10 includes a single or a plurality of information processing apparatuses including an arithmetic device and a storage device. Then, as illustrated in FIG. 2, the control device 10 includes an acquisition unit 11, a control unit 12, and an output unit 13. Each of functions of the acquisition unit 11, the control unit 12, and the output unit 13 can be achieved by the arithmetic device executing a program for achieving each function stored in the storage device. The control device 10 includes a reference information storage unit 14, achieved by the storage device. As illustrated in FIG. 1, the control device 10 is connected to the display device 40 that displays information to an administrator who manages a raising situation of the fish F in the fish tank A.

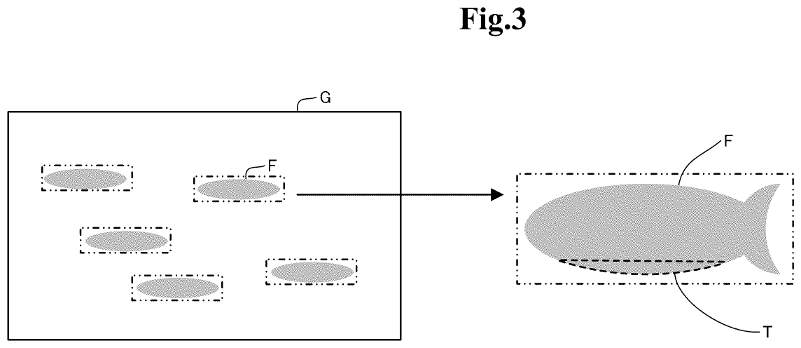

The acquisition unit 11 acquires a captured image G imaged by the camera 20. Then, the acquisition unit 11 detects fish F imaged in the captured image G and acquires abdomen information indicating a state of an abdomen of the fish F. At this time, as illustrated in FIG. 3, the acquisition unit 11 detects a region (for example, rectangle) related to the fish F from the captured image G and acquires a bulging degree of an abdomen T and a satiety level of the fish F in the detected region, as the abdomen information.

Specifically, the acquisition unit 11 first detects the region of the fish F from the captured image G, using a machine learned fish detection model, and detects and acquires the bulging degree of the abdomen T from a shape of the fish F in the region detected by using a machine learned abdomen detection model. The fish detection model and the abdomen detection model are stored, for example, in the reference information storage unit 14.

Here, for example, the fish detection model is constructed by machine learning an appearance image of the fish F in the captured image. As a result, the acquisition unit 11 can detect a region related to the fish F, as indicated by a two-dot chain line rectangle in FIG. 3, by inputting the captured image into the fish detection model.

The abdomen detection model is prepared for each of a type of the fish F and a size of the fish F (for example, length from head to tail), and is constructed by machine learning a correspondence relationship between the shape of the fish F and the bulging degree of the abdomen T. As an example, the shape of the fish F is represented by, information regarding an outer shape, a length from the abdomen to the back at each of a plurality of portions between the head to the tail, or the like. For example, the bulging degree of the abdomen T is represented by a larger numerical value as the bulging degree increases. As a result, the acquisition unit 11 can detect the bulging degree of the abdomen T of the fish F, by inputting information regarding the shape of the detected fish F, into the abdomen detection model related to the size of the detected fish F, among the abdomen detection model related to the type of the fish F raised in the fish tank A. The bulging degree of the abdomen T of the fish F may be detected by any method, and for example, the bulging degree may be calculated by a calculation formula set in advance based on the size or the shape of the fish F.

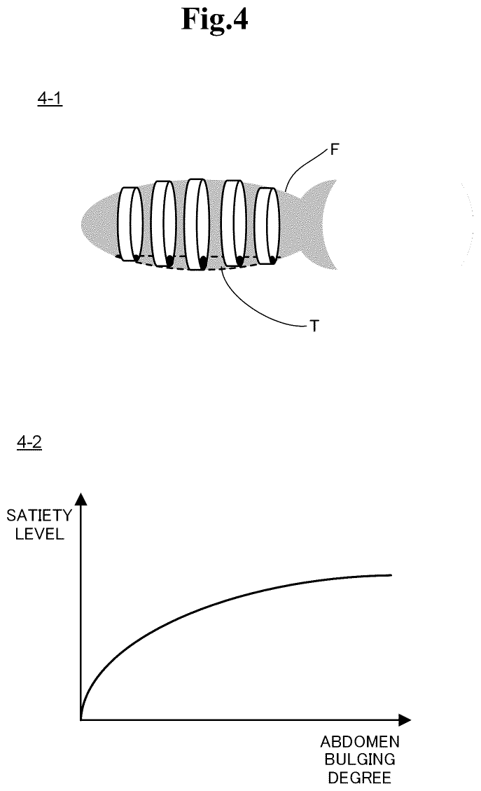

Moreover, the acquisition unit 11 estimates the satiety level of the fish F, based on the bulging degree of the abdomen T of the fish F detected as described above. At this time, data indicating a relationship between the bulging degree and the satiety level is stored in the reference information storage unit 14, and the acquisition unit 11 estimates the satiety level from the bulging degree of the fish F using the data. For example, the data indicating the relationship between the bulging degree and the satiety level may be a satiety level estimation model indicating a relationship between the bulging degree of the abdomen T and the satiety level (black portion in FIG. 4 (4-1)) at each of a plurality of portions between the head and the tail, as illustrated in FIG. 4 (4-1), or may be a graph indicating the relationship between the bulging degree of the abdomen T and the satiety level, as illustrated in FIG. 4 (4-2).

Here, the satiety level estimation model is constructed by machine learning a correspondence relationship between the bulging degree of the abdomen T of the fish F and the satiety level. At this time, the bulging degree of the abdomen T of the fish F and the satiety level may be set as values at each of the plurality of portions between the head and the tail of the fish F, for example, as illustrated in FIG. 4 (4-1). Therefore, the acquisition unit 11 can estimate the satiety level of the entire fish F, by estimating each satiety level from the detected bulging degree of the fish F at each portion and integrating the satiety levels into one value. The satiety level estimation model may be represented by the graph indicating the relationship between the bulging degree of the abdomen T and the satiety level illustrated in FIG. 4 (4-2), and the graph may represent a relationship between the bulging degree of the abdomen of the entire fish F and the satiety level or may represent a relationship between the bulging degree of the fish F at each portion and the satiety level. As a result, the acquisition unit 11 can estimate the satiety level of the entire fish F by estimating the satiety level from the detected bulging degree of the abdomen T of the fish F or estimating each satiety level from each detected bulging degree of the abdomen T at each portion of the fish F and integrating the satiety levels into one value. The satiety level may be estimated from the bulging degree of the abdomen T of the fish F by any method, and for example, the satiety level may be calculated by a calculation formula set in advance based on the bulging degree of the abdomen T of the fish F.

The abdomen detection model and the satiety level estimation model are prepared according to the raising situation of the fish F, and those related to the raising situation may be used. For example, each model may be prepared for each season or may be prepared for each number of raising days of the fish F. Each model may be prepared for each satiety level of the fish F, for example, for each of when the fish F is hungry or when the satiety level is a predetermined satiety level.

Then, the detection of the fish F and the estimation of the bulging degree of the abdomen T and the satiety level by the acquisition unit 11 are performed before starting feeding as described later and also performed during feeding. For example, the detection and the estimation may be performed at constant time intervals such as one-minute intervals or 10-minute intervals or may be performed in response to an input command.

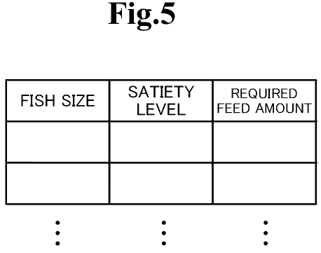

The control unit 12 controls the feeding status by the feeder 30, based on the satiety level estimated as described above. At this time, as illustrated in FIG. 5, the reference information storage unit 14 stores a table indicating a correspondence relationship between the satiety level and a required feed amount, for each of the type and the size of the fish F. The table indicating the correspondence relationship between the satiety level and the required feed amount represents a feed amount necessary for the fish F of which the satiety level has reached a set satiety level. Therefore, the control unit 12 controls the feeding status in such a way as to supply the required feed amount of food related to the satiety level estimated by the acquisition unit 11, from the feeder 30.

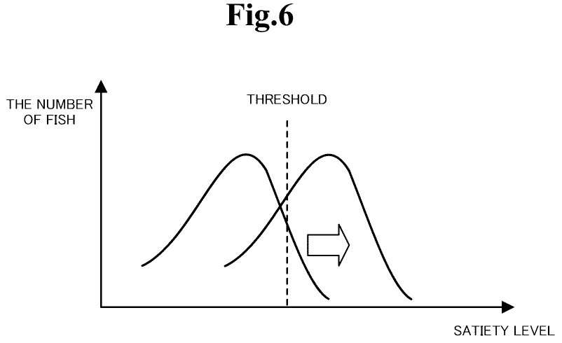

At this time, the control unit 12 estimates the satiety level of each of the plurality of fish F, and as illustrated in FIG. 6, in a case where the number of fish F of which the satiety level exceeds a threshold that is a specific value exceeds a preset number, the control unit 12 controls the feeding status by the feeder 30, in such a way as to supply the required feed amount of food related to the satiety level that is the specific value. For example, the control unit 12 performs control to increase or decrease a feeding speed, that is, a feed amount supplied per unit time, in such a way as to achieve the required feed amount related to the satiety level that the predetermined number of fish F have reached. In a case where the required feed amount has been supplied or in a case where the required feed amount related to the satiety level that the predetermined number of fish F have reached is 0, the control unit 12 controls to stop feeding by the feeder 30.

The output unit 13 outputs the status of the fish F or the status of feeding to be displayed on the display device 40. For example, the output unit 13 outputs information indicating the bulging degree of the abdomen T of the fish F and the satiety level acquired by the acquisition unit 11 as described above. At this time, the output unit 13 may output the number or a ratio of the fish F with respect to the bulging degree of the abdomen T or the value of the satiety level each time when time elapses, that is, may output a temporal change of the bulging degree of the abdomen T of the fish F or the satiety level, together with the number of fish F. For example, the output unit 13 may output that feeding has started or the feeding speed has changed, as the feeding status by the control unit 12 or may output a required feed amount at that time, that is, a feed amount to be supplied. The output unit 13 may output that feeding has stopped.

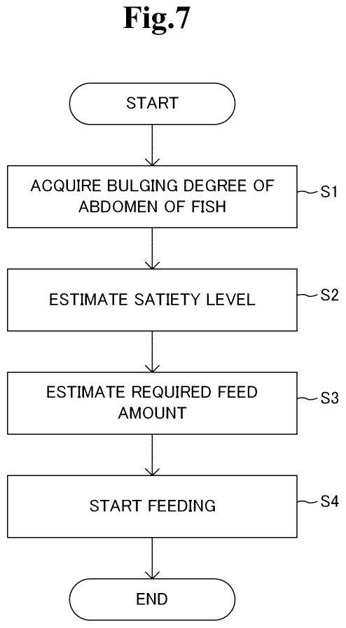

Here, a feeding control operation by the control device 10 will be described in chronological order. First, a control operation before starting feeding to the fish F will be described with reference to FIG. 7. The control device 10 acquires the bulging degree of the abdomen T from the captured image of the fish F before feeding by the acquisition unit 11 (step S1) and estimates the satiety level of the fish F (step S2). At this time, the acquisition unit 11 may acquire the bulging degree of the abdomen T and the satiety level, using the abdomen detection model and the satiety level estimation model prepared in correspondence with the time when the fish F is hungry. Then, the control device 10 estimates the required feed amount according to the satiety level by the control unit 12 (step S3), and controls the feeding status of the feeder 30 in such a way as to supply the estimated required amount of food from the feeder 30 to the fish tank A and starts feeding (step S4).

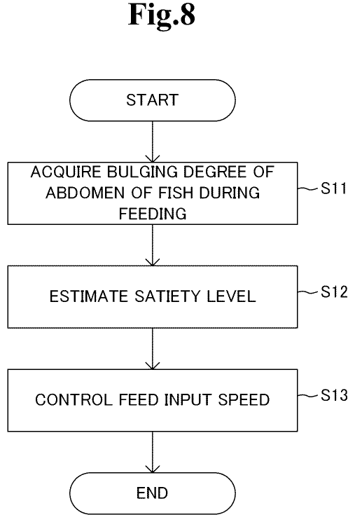

Next, a control operation during feeding to the fish F will be described with reference to FIG. 8. The control device 10 acquires the bulging degree of the abdomen T from the captured image of the fish F during feeding by the acquisition unit 11 (step S11) and estimates the satiety level of the fish F (step S12). At this time, the acquisition unit 10 may acquire the bulging degree of the abdomen T and the satiety level, using the abdomen detection model and the satiety level estimation model prepared in correspondence with the time of feeding to the fish F. Then, the control device 10 estimates the required feed amount according to the satiety level by the control unit 12 and controls the feeding speed of the feeder 30 in such a way as to supply the estimated required amount of food from the feeder 30 to the fish tank A (step S13). For example, the control unit 12 performs control to increase or decrease the feed amount to be supplied from the feeder 30 per unit time.

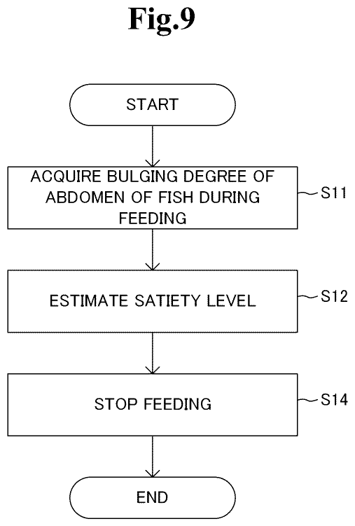

Next, a control operation at the time when a predetermined time has elapsed from start of feeding to the fish F will be described with reference to FIG. 9. The control device 10 acquires the bulging degree of the abdomen T from the captured image of the fish F during feeding by the acquisition unit 11 (step S11) and estimates the satiety level of the fish F (step S12). At this time, the acquisition unit 10 may acquire the bulging degree of the abdomen T and the satiety level, using the abdomen detection model and the satiety level estimation model prepared in correspondence with the time when the fish F is full. Then, the control device 10 estimates the required feed amount according to the satiety level by the control unit 12, and in a case where a stop criterion is satisfied, such as a case where the estimated required amount is 0, the control device 10 performs control to stop feeding from the feeder 30 (step S14).

As described above, in the present example embodiment, the status of the abdomen of the fish F, in particular, the status of the abdomen of the fish F during feeding is acquired, and the feeding speed is controlled based on this, or feeding is stopped. Therefore, it is possible to appropriately feed the fish F. In the present example embodiment, since feeding is controlled based on the bulging degree of the abdomen of the fish F or the satiety level, it is possible to more appropriately perform feeding.

Although the control unit 12 controls the feeding status by the feeder 30 based on the satiety level of the fish F in the above, the feeding status by the feeder 30 may be controlled based on the bulging degree of the abdomen T of the fish F, or the feeding status by the feeder 30 may be controlled, based on the abdomen information indicating any abdomen state of the fish F acquired from the captured image.

### Second Example Embodiment

Next, a second example embodiment of the present disclosure will be described.

A control device 10 according to the present example embodiment has a configuration similar to that of the above first example embodiment. In addition, the control device 10 includes the following configuration. Hereinafter, a configuration different from the above will be mainly described.

An output unit 13 of the control device 10 according to the present example embodiment has a function for detecting an abnormality in a fish tank A and outputting an alert indicating the abnormality in such a way as to display the alert on a display device 40. For example, the output unit 13 monitors a change in a bulging degree of an abdomen of fish F or a satiety level with the lapse of time during feeding and outputs the alert in a case where the change is determined as an abnormality according to a preset criterion. As an example, in a case where the bulging degree of the abdomen of the fish F or the satiety level does not increase even during feeding, or in a case where the change in the bulging degree of the abdomen of the fish F or the satiety level with respect to a feeding amount is not a preset change, the change is determined as an abnormality, and the alert is output.

As a result, an administrator who has received the alert or the like can quickly cope with the abnormality, by checking a status of the fish tank A or checking a status of a feeder 30.

### Third Example Embodiment

Next, a third example embodiment of the present disclosure will be described.

A raising system according to the present example embodiment is applicable to not only a case of farming the fish F but also a case of raising any animal, and is applicable, for example, in the livestock industry in which cows, pigs, birds, or the like are raised. As an example, in a case where cows are raised, a camera 20 and a feeder 30 are installed in a cattle barn and a farm. Then, the cow is imaged by the camera 20, a bulging degree of an abdomen of the cow imaged in a captured image and a satiety level are acquired by a control device 10, and a feeding status by the feeder 30 is controlled based on the bulging degree and the satiety level. As a result, it is possible to appropriately feed any animals.

### Fourth Example Embodiment

Next, a fourth example embodiment of the present disclosure will be described with reference to the drawings. In the present example embodiment, an outline of the information processing apparatus and the like described in the above example embodiment will be illustrated. The drawings may relate to any example embodiment.

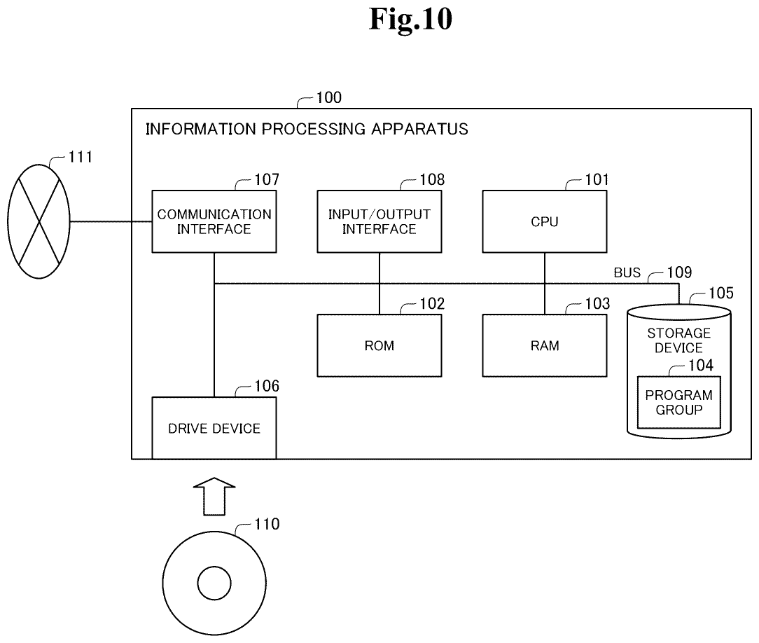

First, a hardware configuration of an information processing apparatus 100 according to the present disclosure will be described. The information processing apparatus 100 is constituted by a general information processing apparatus and, in one example, is equipped with the hardware configuration as follows, as illustrated in FIG. 10.
Central Processing Unit (CPU) 101 (arithmetic device)
Read Only Memory (ROM) 102 (storage device)
Random Access Memory (RAM) 103 (storage device)
Program group 104 to be loaded into RAM 103
Storage device 105 storing program group 104
Drive device 106 for performing reading and writing on storage medium 110 outside information processing apparatus
Communication interface 107 connected to communication network 111 outside information processing apparatus
Input/output interface 108 for inputting and outputting data
Bus 109 for connecting each component

FIG. 10 illustrates an example of the hardware configuration of the information processing apparatus that is the information processing apparatus 100, and the hardware configuration of the information processing apparatus is not limited to the above case. For example, the information processing apparatus may be constituted by a part of the above configuration such as not including the drive device 106. Instead of the CPU described above, the information processing apparatus can use a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, a combination of these, or the like.

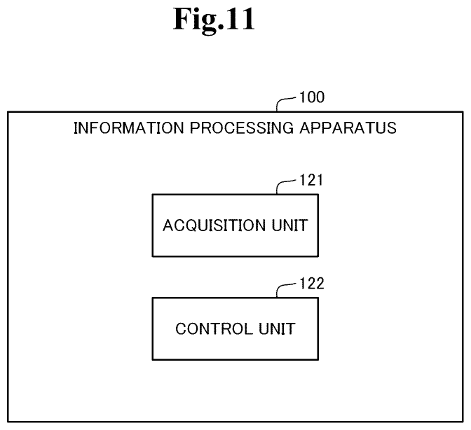

Then, an acquisition unit 121 and a control unit 122 illustrated in FIG. 11 can be constructed and equipped in the information processing apparatus 100 by the CPU 101 acquiring the program group 104 and executing the acquired program group 104 by itself. The program group 104 is stored, for example, in the storage device 105 or the ROM 102 in advance, and the CPU 101 loads and executes the stored program group 104 on the RAM 103, as necessary. The program group 104 may be supplied to the CPU 101 via the communication network 111, or the drive device 106 may read the programs stored in the storage medium 110 in advance and supply the read programs to the CPU 101. However, the acquisition unit 121 and the control unit 122 described above may be constructed by a dedicated electronic circuit for achieving the means.

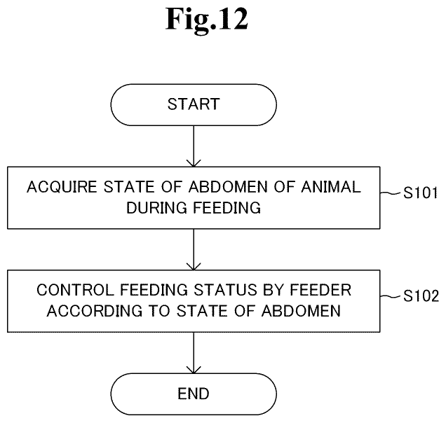

The acquisition unit 121 acquires the abdomen information indicating the state of the abdomen of the animal during feeding by the feeder (step S101 in FIG. 12). The control unit 122 controls the feeding status by the feeder, based on the abdomen information.

In the above configuration, for example, the information processing apparatus 100 images the animal during feeding and acquires the abdomen information such as the bulging degree of the abdomen or the satiety level from the captured image. Then, the information processing apparatus 100 controls the feeding status by controlling a feeding speed or stopping feeding, based on the abdomen information such as the bulging degree of the abdomen of the animal during feeding or the satiety level. As a result, it is possible to suppress excessive or insufficient feeding to the animal, and to perform appropriate feeding.

At least one or more of the functions of the acquisition unit 121 and the control unit 122 described above may be executed by an information processing apparatus installed and connected at any place on a network, that is, may be executed on so-called cloud computing.

The programs described above can be stored using various types of non-transitory computer readable media and supplied to a computer. The non-transitory computer readable media include various types of tangible recording media. Examples of the non-transitory computer readable medium include a magnetic recording medium (for example, flexible disk, magnetic tape, or hard disk drive), an optical magnetic recording medium (for example, magneto-optical disc), a Compact Disc Read Only Memory (CD-ROM), a Compact Disc Recordable (CD-R), a Compact Disc Rewritable (CD-R/W), and a semiconductor memory (for example, mask ROM, Programmable ROM (PROM), Erasable PROM (EPROM), flash ROM, or Random Access Memory (RAM)). The programs may also be supplied to the computer by various types of transitory computer readable media. Examples of the transitory computer readable media include electrical signals, optical signals, and electromagnetic waves. The transitory computer readable media can supply the programs to the computer via a wired communication path such as wires or an optical fiber or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment described above can be appropriately combined with other embodiments.

### Supplementary Note

Some or all of the above example embodiments may be described as in the following Supplementary Notes. Hereinafter, an outline of configurations of the information processing apparatus, the information processing method, and the program according to the present disclosure will be described. However, the present disclosure is not limited to the configurations described in the following Supplementary Notes.

Some or all of the configurations described in the Supplementary Notes 2 to 8 dependent on the Supplementary Note 1 described below and the functions according to those configurations can also be dependent on the other Supplementary Notes 9, 10, and 11 by a dependency relationship similar to that of the Supplementary Notes 2 to 8. Moreover, some or all of the configurations described as the Supplementary Notes and the functions according to those configurations can be similarly dependent on not only Supplementary Notes 1, 9, 10 and 11, but also various pieces of similar hardware and software, and various types of recording means that record the software, or systems without departing from the above-described example embodiments.

### Supplementary Note 1

An information processing apparatus including:
an acquisition unit configured to acquire abdomen information indicating a state of an abdomen of an animal during feeding by a feeder; and
a control unit configured to control a feeding status by the feeder, based on the abdomen information.

### Supplementary Note 2

The information processing apparatus according to supplementary note 1, in which
the control unit stops feeding by the feeder, based on the abdomen information.

### Supplementary Note 3

The information processing apparatus according to supplementary note 1, in which
the control unit controls a feeding speed by the feeder, based on the abdomen information.

### Supplementary Note 4

The information processing apparatus according to supplementary note 1, in which
the acquisition unit detects a bulging degree of the abdomen of the animal during feeding, based on the abdomen information, and
the control unit controls a feeding status by the feeder according to the bulging degree.

### Supplementary Note 5

The information processing apparatus according to supplementary note 4, in which
the acquisition unit estimates a satiety level of the animal based on the bulging degree of the abdomen, and
the control unit controls the feeding status by the feeder according to the estimated satiety level.

### Supplementary Note 6

The information processing apparatus according to supplementary note 4, in which
the control unit controls the feeding status by the feeder, according to the bulging degrees of a predetermined number, that is, a plurality of the animals.

### Supplementary Note 7

The information processing apparatus according to supplementary note 2, in which
the acquisition unit detects a bulging degree of the abdomen of the animal during feeding, based on the abdomen information, and
the control unit stops feeding by the feeder, in a case where the bulging degrees of a predetermined number, that is, a plurality of the animals satisfy a preset criterion.

### Supplementary Note 8

The information processing apparatus according to supplementary note 5, in which
information regarding a required feed amount related to the satiety level is stored according to a size of the animal,
the acquisition unit acquires the size of the animal and estimates the satiety level of the animal, and
the control unit specifies the required feed amount, based on the acquired size of the animal and the estimated satiety level and controls the feeding status by the feeder based on the required feed amount.

### Supplementary Note 9

An information processing method performed by an information processing apparatus, including:
acquiring abdomen information indicating a state of an abdomen of an animal during feeding by a feeder; and
controlling a feeding status by the feeder, based on the abdomen information.

### Supplementary Note 10

A program for causing an information processing apparatus to execute processing for:
acquiring abdomen information indicating a state of an abdomen of an animal during feeding by a feeder; and
controlling a feeding status by the feeder, based on the abdomen information.

### Supplementary Note 11

An information processing system including:
a feeder configured to perform feeding into a space where an animal is raised;
an imaging device configured to image the animal; and
an information processing apparatus configured to acquire a captured image by the imaging device and control a feeding status by the feeder, in which
the information processing apparatus includes
an acquisition unit that acquires abdomen information indicating a state of an abdomen of the animal during feeding by the feeder, from the captured image by the imaging device, and
a control unit that controls a feeding status by the feeder, based on the abdomen information.

### REFERENCE SIGNS LIST

10 control device
11 acquisition unit
12 control unit
13 output unit
14 reference information storage unit
20 camera
30 feeder
40 display device
100 information processing apparatus
101 CPU
102 ROM
103 RAM
104 program group
105 storage device
106 drive device
107 communication interface
108 input/output interface
109 bus
110 storage medium
111 communication network
121 acquisition unit
122 control unit

1. An information processing apparatus comprising:
at least one memory configured to store processing instructions; and
at least one processor configured to execute the processing instructions to:
acquire abdomen information indicating a state of an abdomen of an animal during feeding by a feeder; and
control a feeding status by the feeder, based on the abdomen information.

2. The information processing apparatus according to claim 1, wherein the at least one processor is configured to execute the processing instructions to stop feeding by the feeder, based on the abdomen information.

3. The information processing apparatus according to claim 1, wherein the at least one processor is configured to execute the processing instructions to control a feeding speed by the feeder, based on the abdomen information.

4. The information processing apparatus according to claim 1, wherein the at least one processor is configured to execute the processing instructions to:
detect a bulging degree of the abdomen of the animal during feeding, based on the abdomen information; and
control a feeding status by the feeder according to the bulging degree.

5. The information processing apparatus according to claim 4, wherein the at least one processor is configured to execute the processing instructions to:
estimate a satiety level of the animal based on the bulging degree of the abdomen; and
control the feeding status by the feeder according to the estimated satiety level.

6. The information processing apparatus according to claim 4, wherein the at least one processor is configured to execute the processing instructions to control the feeding status by the feeder, according to the bulging degrees of a predetermined number, that is, a plurality of the animals.

7. The information processing apparatus according to claim 2, wherein the at least one processor is configured to execute the processing instructions to:
detect a bulging degree of the abdomen of the animal during feeding, based on the abdomen information; and
stop feeding by the feeder, in a case where the bulging degrees of a predetermined number, that is, a plurality of the animals satisfy a preset criterion.

8. The information processing apparatus according to claim 5, wherein the at least one processor is configured to execute the processing instructions to:
store information regarding a required feed amount related to the satiety level according to a size of the animal;
acquire the size of the animal and estimate the satiety level of the animal; and
specify the required feed amount, based on the acquired size of the animal and the estimated satiety level and control the feeding status by the feeder based on the required feed amount.

9. The information processing apparatus of claim 1, wherein the at least one processor is configured to execute the processing instructions to estimate a satiety level of the animal from the abdominal information using a pre-trained machine learning model.

10. The information processing apparatus of claim 1, wherein the at least one processor is configured to execute the processing instructions to generate information for supporting a user's decision making regarding feeding management, wherein the information includes at least one of an estimated satiety level of the animal, a required feed amount, or an alert indicating an abnormality.

11. An information processing method performed by an information processing apparatus, comprising:
acquiring abdomen information indicating a state of an abdomen of an animal during feeding by a feeder; and
controlling a feeding status by the feeder, based on the abdomen information.

12. The information processing method according to claim 11, further comprising:
stopping feeding by the feeder, based on the abdomen information.

13. The information processing method according to claim 11, further comprising:
controlling a feeding speed by the feeder, based on the abdomen information.

14. The information processing method according to claim 11, further comprising:
detecting a bulging degree of the abdomen of the animal during feeding, based on the abdomen information; and
controlling a feeding status by the feeder according to the bulging degree.

15. The information processing method according to claim 14, further comprising:
estimating a satiety level of the animal based on the bulging degree of the abdomen; and
controlling the feeding status by the feeder according to the estimated satiety level.

16. The information processing method according to claim 14, further comprising:
controlling the feeding status by the feeder, according to the bulging degrees of a predetermined number, that is, a plurality of the animals.

17. The information processing method according to claim 12, further comprising:
detecting a bulging degree of the abdomen of the animal during feeding, based on the abdomen information; and
stopping feeding by the feeder, in a case where the bulging degrees of a predetermined number, that is, a plurality of the animals satisfy a preset criterion.

18. The information processing method according to claim 15, further comprising:
storing information regarding a required feed amount related to the satiety level according to a size of the animal;
acquiring the size of the animal and estimating the satiety level of the animal; and
specifying the required feed amount, based on the acquired size of the animal and the estimated satiety level and controlling the feeding status by the feeder based on the required feed amount.

19. A non-transitory computer-readable storage medium storing a program for causing an information processing apparatus to execute processing for:
acquiring abdomen information indicating a state of an abdomen of an animal during feeding by a feeder; and
controlling a feeding status by the feeder, based on the abdomen information.
